(19) United States
(12) Patent Application Publication
(10) Pub. No.: US 2025/0131803 A1
(43) Pub. Date: Apr. 24, 2025

(54) Intelligent Alert System for Warehouse Environments and Related Methods

(71) Applicants: Isura Ranatunga, Concord, CA (US); Channa Ranatunga, Grand Prairie, TX (US); Sandeep Suresh, Emeryville, CA (US)

(72) Inventors: Isura Ranatunga, Concord, CA (US); Channa Ranatunga, Grand Prairie, TX (US); Sandeep Suresh, Emeryville, CA (US)

(21) Appl. No.: 18/382,475

(22) Filed: Oct. 21, 2023

(51) Int. Cl. G08B 7/06; G06Q 10/063

(52) U.S. Cl. CPC G08B 7/06; G06Q 10/063

(57) ABSTRACT

The invention describes a digitally triggered alert system specifically tailored for warehouse environments. A centralized digital interface receives inputs from various sources, including human personnel, sensors, automation systems, and machine learning algorithms monitoring said sensors and comparing the sensor data with expected results based on real-time warehouse data. Upon receiving an alert trigger from one of the input mechanisms, the system sends digital notifications to designated personnel, and may also activate one or more local physical alert devices within the warehouse environment.

### FIELD OF INVENTION

The present invention relates to alert systems within warehouse environments. Specifically, it pertains to a digitally triggered alert system that integrates multiple sources of input for generating comprehensive and timely alerts.

### BACKGROUND

In the context of modern warehouse management, effective communication systems are indispensable for ensuring smooth operations. Traditional alert systems, such as andon lights, have been extensively employed for signaling operational hiccups and thereby requiring immediate attention. However, these systems often suffer from limitations in the breadth and depth of their applications. They are generally triggered manually, requiring human intervention to signal issues. This setup inevitably delays reaction time and also necessitates constant human vigilance, which is prone to error.

Moreover, many of these traditional systems are standalone units that do not readily integrate with other components of an advanced warehouse management system, such as sensors, automated machinery, and real-time data analytics platforms. As a result, warehouse personnel are burdened with the task of correlating signals from these disparate systems to diagnose and act upon issues effectively. Such a manual process increases the likelihood of errors and reduces operational efficiency.

Another drawback is the limited modality of the alert. Often restricted to visual or audible signals within the warehouse, traditional alert systems lack the means to instantaneously inform off-site team leads or management personnel who may not be present within the warehouse premises. In addition, the lack of specific information related to the alert—such as the type of issue, its location, or the personnel involved—can make the resolution process cumbersome and time-consuming.

The advent of digital transformation technologies like Internet of Things (IoT), artificial intelligence (AI), and machine learning (ML) has ushered in a new era of possibilities for warehouse management. These technologies are capable of gathering, analyzing, and reacting to real-time data to improve operational efficiency. However, the lack of integration between these advanced technologies and existing alert systems has left a gap in fully realizing an efficient, automated, and intelligent warehouse management system.

It is within this context that the present invention is provided.

### SUMMARY

The present invention provides a system and method for generating and disseminating alerts in a warehouse setting through an integrated approach. A centralized digital interface receives and processes various types of input triggers, which can emanate from human personnel, sensors, automation systems, and machine learning algorithms. Upon recognition of a predefined condition that necessitates an alert, the system distributes digital notifications to designated recipients, and may also activate local visual and audible indicators within the warehouse environment. This arrangement facilitates prompt and effective responses to a wide range of operational issues within the warehouse.

Thus, according to one aspect of the present disclosure there is provided an intelligent alert system for warehouse environments, the system comprising: at least one first user device; at least one second user device; at least one sensor device located within a warehouse environment.

The system further comprises one or more servers, the one or more servers being configured to: continuously monitor sensed data from the at least one sensor for a pre-defined alert trigger; receive real-time warehouse data relating to the warehouse environment; execute a machine learning algorithm to monitor the at least one sensor and identify discrepancies between the sensed data an expected parameter based on the warehouse data; receive an alert trigger from one of: a received input signal from the at least one first user device; a pre-defined trigger being identified in the sensed data; and the machine learning algorithm; and in response to the alert trigger, send a notification to one or more of the second user devices.

In some embodiments, the system further comprises one or more integrated automation and robotics systems having their own sensors and processing software, and which are communicatively coupled to the one or more servers, and wherein the one or more servers are further configured alert triggers from said one or more automation and robotics systems.

In some embodiments, one or more of the first user devices are handheld devices, tablets, monitors, or other suitable user device types and are configured to send alert triggers via accessing a digital interface hosted by the one or more servers.

In some embodiments, one or more of the first user devices are configured to manually trigger alerts using a dedicated physical input trigger.

In some embodiments, the at least one sensor is selected from the group consisting of: weight scales, cameras, and barcode scanners.

In some embodiments the system further comprises at least one physical alert device located within the same warehouse environment, and the one or more servers are further configured to trigger the at least one physical alert device in response to the alert trigger.

The at least one physical alert device may include at least one set of alert lights, some of which may be andon lights.

The physical alert devices may also comprise a set of audible alarm systems. In other examples the physical alert devices may include wearable devices that vibrate upon receiving an alert notification.

In some embodiments, the real-time warehouse data is received via one or more of: WMS systems, ERP systems, and CRM systems associated with the warehouse environment.

In some embodiments, the at least one second user device is associated with a user profile of a manager or team lead of the warehouse environment. The notification to the second user device may be in the form of an IM, text message, or e-mail to the associated user profile of the second user device.

In some embodiments, the alert lights are andon lights.

### BRIEF DESCRIPTION OF THE DRAWINGS

Various embodiments of the invention are disclosed in the following detailed description and accompanying drawings.

FIG. 1 provides a block diagram overview of an example implementation of the system architecture.

FIG. 2 depicts a process flow diagram detailing the method carried out by the central digital interface servers in the example implementation.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DESCRIPTION OF DRAWINGS

The present invention relates to a digitally triggered alert system designed for warehouse environments. Central to the invention is a digital interface that receives various types of inputs to activate alert systems. These inputs can come from human personnel through handheld devices, from sensors such as cameras and weight scales, from automation and robotics systems, or from machine learning algorithms that analyze real-time warehouse data. Upon receiving an alert trigger, the system activates visual and auditory cues through andon lights and audible alarms. Additionally, the system sends out digital notifications like text messages or emails to the designated team leads and management personnel.

The system consists of multiple hardware components that interact through network hardware to form a cohesive unit. At the core is the digital interface, which serves as a centralized control unit capable of processing alert triggers from diverse sources. This interface is connected to traditional andon lights and audible alarms that serve as immediate, local alert mechanisms. Various types of sensors, such as weight scales and barcode scanners, feed data into the system. Human personnel can also input manual alerts through handheld devices that communicate with the central digital interface. Furthermore, automation and robotics systems integrated into the warehouse operations can send alert triggers to the digital interface. To support this network of hardware components, routers, switches, and network cables are employed. A server is used to store and process data from these various sources and to host the machine learning algorithms that help in decision-making.

On the software side, the system requires a series of steps for operation. Initial configuration involves setting up all hardware devices and ensuring they are networked properly. Subsequently, the types of alerts and triggers are defined in the digital interface. Sensors are calibrated for accurate data readings and are configured to send this data to the digital interface. Machine learning algorithms are trained and deployed to analyze real-time data and, based on predefined parameters, to trigger alerts. A user interface is developed to facilitate manual input from human personnel. Secure communication protocols are established to ensure safe data transfer between the hardware components and the digital interface. The system is then rigorously tested for reliability and accuracy before being deployed. After deployment, monitoring and maintenance are carried out to keep the system up to date and calibrated. The recorded data from incidents is analyzed for trends and used to refine the machine learning algorithms for improved performance.

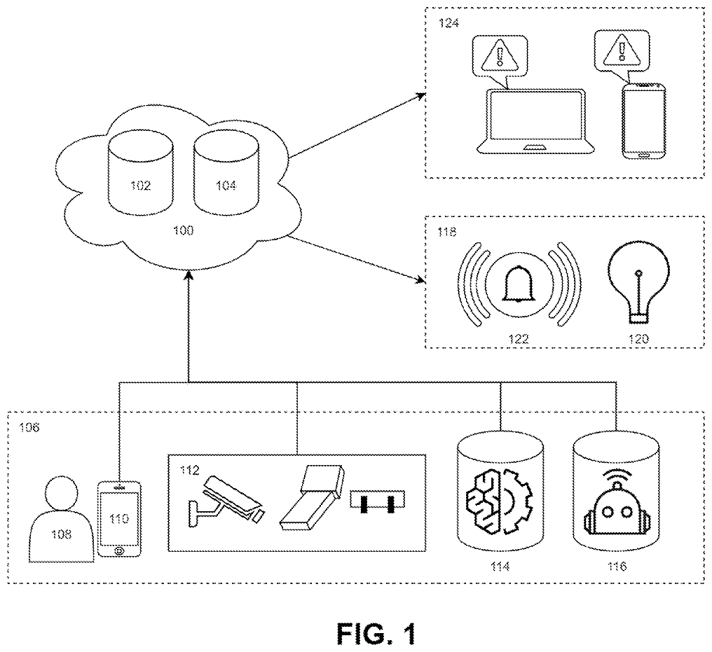

In FIG. 1, a block diagram provides an overview of an example implementation of the system architecture. The central component of this system is a central digital interface 100 that operates over a cloud architecture. Within this cloud-based environment are one or more servers 102 and databases 104, responsible for hosting the digital interface and storing real-time and historical data respectively.

Connected to the central digital interface 100 via cloud communication is a block representing input alert triggers in a warehouse environment 106. The input triggers include multiple elements. Firstly, a warehouse operator 108 is shown interfacing/interacting with a user device 110 through which manual alert triggers can be inputted. The user device 110 features a display screen, facilitating interaction with the digital interface 100 hosted by the cloud servers 102. Secondly, a set of sensors 112, such as cameras, scanners, and weighing scales, is depicted. These sensors are monitored by the servers 102 for pre-defined alert triggers within the warehouse environment. Thirdly, an AI/ML algorithm 114 is incorporated, which monitors the sensors 112 for discrepancies based on real-time data received via systems like Warehouse Management Systems (WMS), Enterprise Resource Planning (ERP) systems, and Customer Relationship Management (CRM) systems associated with the warehouse environment. Finally, Robotics and Automation devices 116, including robotic effectors and conveyors, are part of the input triggers. These devices have their own sensors and processing systems but are integrated with the central digital interface 100 to send alert triggers should they identify a discrepancy.

A separate block connected to the central digital interface 100 displays warehouse alert devices 118. When an alert trigger is received by the servers 102, these alert devices are activated. This block includes a set of andon lights 120 and an audible alarm speaker 122. These are designed to garner immediate attention within the warehouse environment.

A third separate block is connected to the cloud servers 102, indicating the second user devices 124. These are the devices operated by team leads or managers within the warehouse. Notifications, whether by text, email, or other means, are sent to these second user devices 124 when an alert trigger is recognized by the central digital interface 100.

One or more of the operations and calculations described herein may be performed by a cloud infrastructure comprising one or more servers and databases. This is merely an example infrastructure however, the servers need not necessarily be cloud-based. The cloud infrastructure may for example comprise a database configured to receive and store multimedia content and user data for a plurality of user accounts and a set of connected servers or nodes configured to enact the operations as disclosed herein.

The cloud infrastructure is configured to communicate with the user devices by various means over the network architecture. The user devices include devices configured to communicate with the cloud infrastructure via a communications tower. These devices may include but are not limited to a smartphone, a laptop, and a tablet computer with e-mail and web browser application software.

Any one of the user devices may be operationally coupled to a wide area network (WAN) such as the Internet with a wireless connection. The wireless clients may be communicatively coupled to the WAN via a Wi-Fi (or Bluetooth) access point that is communicatively coupled to a modem, which is communicatively coupled to the WAN. The wireless clients may also be communicatively coupled to the WAN using a proprietary carrier network that includes communication tower.

While a specific set of user devices are listed as examples of the architecture, the user devices may in fact be any suitable device. For example, user devices could include a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

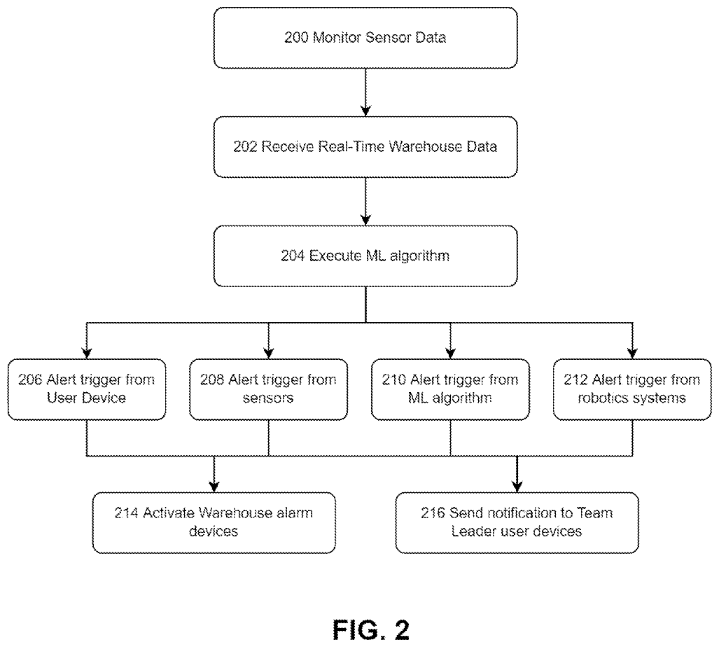

In FIG. 2, a process flow diagram illustrates a method executed by the servers of the central digital interface in an example implementation. The diagram sets forth a sequential series of steps detailing how the server operations contribute to the intelligent alert system in a warehouse environment.

The process starts with the Monitor Sensor Data Block 200. In this initial step, the server continuously observes data from at least one sensor in the warehouse, looking for pre-defined alert triggers.

Following this is the Receive Real-time Warehouse Data Block 202, wherein the server collects real-time data related to the warehouse environment. This information can include but is not limited to, the status of inventory, personnel movement, and operational conditions.

Subsequent to this is the Execute ML Algorithm Block 204. During this phase, the machine learning algorithm is deployed to scrutinize the data gathered from the sensor or sensors. The algorithm identifies any discrepancies between the sensed data and expected parameters, which are established based on the received warehouse data.

The process then diverges into four separate Receive Alert Trigger Blocks. These blocks delineate the different mechanisms by which an alert trigger can be received:
1. The first block 206 is initiated when an input signal is received from at least one first user device.
2. The second block 208 represents the condition where a pre-defined trigger is identified in the sensed data.
3. The third block 210 illustrates the triggering of an alert by the machine learning algorithm itself after identifying a discrepancy.
4. The fourth block 212 indicates the receipt of a trigger from robotics and automation systems deployed within the warehouse.

After the trigger is received, two final steps are executed concurrently. The Activate Warehouse Alarm Devices Block 214 represents the activation of one or more physical alert devices within the warehouse. These devices can be alert lights, audible alarms, or other physical indicators designed to attract immediate attention. Simultaneously, the Send Notification Block 216 denotes that a notification is sent to one or more of the second user devices. These devices are generally operated by the warehouse team leads or managers, and the notification could be in the form of a text, email, or other communication methods.

### AI Sensor Analysis Module Implementation

The Machine Learning algorithms utilised in the system may be configured to process images and videos, utilizing illustrative image processing libraries like OpenCV or equivalent, to extract features indicative of potential issues within the warehouse that may require an alert to be triggered. It may implement object detection and recognition to assess anomalies, defects, or damages within the items, or missing items.

Machine Learning models within this embodiment may be developed and trained using exemplary frameworks such as TensorFlow or PyTorch or other suitable frameworks, and they may employ supervised or unsupervised learning approaches based on historical data patterns related to warehouse product conditions and expected patterns. These models aim to predict appropriate actions based on the extracted features.

Artificial Intelligence algorithms may be designed to structure and execute decisions, integrating with the outputs from the Machine Learning models. They may incorporate predefined rules, constraints, or decision trees related to product handling based on the real-time warehouse data. These algorithms are optimized to prioritize actions considering various factors, and they may employ equivalent rule-based systems or decision trees to associate specific product conditions and rules.

Integration and interoperability with existing systems is crucial in this illustrative embodiment. Suitable APIs and middleware solutions may be employed to connect the developed systems with other components within the warehouse data management system.

### Network Components

A server as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system for intelligent warehouse alert generation and related methods have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An intelligent alert system for warehouse environments, the system comprising:
at least one first user device;
at least one second user device;
at least one sensor device located within a warehouse environment;
one or more servers, the one or more servers being configured to:
continuously monitor sensed data from the at least one sensor for a pre-defined alert trigger;
receive real-time warehouse data relating to the warehouse environment;
execute a machine learning algorithm to monitor the at least one sensor and identify discrepancies between the sensed data an expected parameter based on the warehouse data;
receive an alert trigger from one of:
a received input signal from the at least one first user device;
a pre-defined trigger being identified in the sensed data; and
the machine learning algorithm; and
in response to the alert trigger, send a notification to one or more of the second user devices.

2. An intelligent alert system according to claim 1, wherein the system further comprises one or more integrated automation and robotics systems having their own sensors and processing software, and which are communicatively coupled to the one or more servers, and wherein the one or more servers are further configured alert triggers from said one or more automation and robotics systems.

3. An intelligent alert system according to claim 1, wherein one or more of the first user devices are handheld devices configured to send alert triggers via accessing a digital interface hosted by the one or more servers.

4. An intelligent alert system according to claim 1, wherein one or more of the first user devices are configured to manually trigger alerts using a dedicated physical input trigger.

5. An intelligent alert system according to claim 1, wherein the at least one sensor is selected from the group consisting of: weight scales, cameras, and barcode scanners.

6. An intelligent alert system according to claim 1, wherein the system further comprises at least one physical alert device located within the same warehouse environment, and the one or more servers are further configured to trigger the at least one physical alert device in response to the alert trigger.

7. An intelligent alert system according to claim 6, wherein the at least one physical alert device includes at least one set of alert lights.

8. An intelligent alert system according to claim 7, wherein the alert lights include andon lights.

9. An intelligent alert system according to claim 6, wherein the physical alert devices further comprise a set of audible alarm systems.

10. An intelligent alert system according to claim 1, wherein the real-time warehouse data is received via one or more of: WMS systems, ERP systems, and CRM systems associated with the warehouse environment.

11. An intelligent alert system according to claim 1, wherein the at least one second user device is associated with a user profile of a manager or team lead of the warehouse environment.

12. An intelligent alert system according to claim 11, wherein the notification to the second user device is in the form of an IM, text message, or e-mail to the associated user profile of the second user device.
